(19) United States
(12) Patent Application Publication
(10) Pub. No.: US 2025/0058550 A1
(43) Pub. Date: Feb. 20, 2025

(54) PROTECTIVE STRUCTURES FOR LAMINATES

(71) Applicant: DelStar Technologies, Inc., Alpharetta, GA (US)

(72) Inventors: Jeffrey Pratt, Orange, MA (US); Thomas C. Niziolek, Feeding Hills, MA (US)

(21) Appl. No.: 18/795,409

(22) Filed: Aug. 6, 2024

Related U.S. Application Data
(60) Provisional application No. 63/519,422, filed on Aug. 14, 2023.

(51) Int. Cl. B32B 27/08; B32B 7/06; B32B 27/36; B32B 27/40

(52) U.S. Cl. CPC B32B 27/08; B32B 7/06; B32B 27/36; B32B 27/40; B32B 2255/10; B32B 2255/26; B32B 2274/00; B32B 2307/412; B32B 2307/414; B32B 2307/7376; B32B 2307/748

(57) ABSTRACT

Protective structures for use with laminates and laminates including the protective structure are provided that may be used in a variety of different applications, such as shatter resistant windows for vehicles and buildings. A protective structure comprises a first layer comprising polycarbonate (PC), polyethylene terephthalate (PET), thermoplastic polyurethane (TPU), acrylic or a combination thereof. The first layer has a first surface and a second surface opposite the first surface. The structure further includes a hard coating on the first surface of the first layer and a second layer comprising a thermoplastic polyurethane (TPU) in contact with the second surface of the first layer. Forming a protective structure into a single film or layer reduces material handling and cost. In addition, this structure has fewer independent webs and can be manufactured with a reduced thickness, thereby further reducing manufacturing costs.

### CROSS-REFERENCE TO RELATED APPLICATIONS

This application claims the benefit of U.S. Provisional Application Ser. No. 63/519,422, filed Aug. 14, 2023, the complete disclosure of which is incorporated herein by reference for all purposes.

### TECHNICAL FIELD

This description generally relates to protective structures, such as films, layers, coatings, or covers, for use in laminated assemblies and more particularly to exterior safety films for use in shatter resistant windows.

### BACKGROUND

Spall is a term that refers to the splinters or shards that break off from a solid piece of glass when the glass shatters. The spall flies inward after the window is struck by strong winds or an object from the outside of a vehicle or building, which can cause significant laceration injuries. Broken glass injuries can be life threatening, result in permanent scarring or cause dismemberment.

Safety or “anti-spall” window films provide an additional barrier that may increase the shatter and/or penetration resistance of glass, thereby improving the ballistic and security properties of the window. These protective films typically include a polyethylene terephthalate (PET) layer with a scratch resistant exterior hard coat. The PET layer is adhered to the outer surface of the glass with an adhesive interlayer to protect individuals and property from the glass spalling.

### SUMMARY

Protective structures for use with laminates and laminates are provided that may be used in a variety of different applications, such as windows for vehicles and buildings. The laminates may be particularly useful in, for example, applications requiring shatter or impact resistance, such as shatter resistance and/or bulletproof glass, sunroofs, windshields, light bulbs, skylights, security doors, screen protectors, curtain walls, mass transit vehicles, marine vessels, military installations, critical infrastructure and the like.

In one aspect, a protective structure comprises a first layer comprising selected from the group consisting of polycarbonate (PC), polyethylene terephthalate (PET), thermoplastic polyurethane (TPU), acrylic and a combination thereof and having a first surface and a second surface opposite the first surface. The structure further comprises a hard coating on the first surface of the first layer and a second layer comprising a thermoplastic polyurethane (TPU) in contact with the second surface of the first layer.

In embodiments, the TPU layer is extruded directly onto the first layer to form a single structure, film or layer. In an exemplary embodiment, the first layer comprises PET. Forming a protective structure with a single layer of TPU and PET reduces material handling and cost. In addition, this structure has fewer independent webs and can be manufactured with a reduced thickness, thereby further reducing manufacturing costs.

In embodiments, the structure has a thickness of about 0.015 inches to about 0.020 inches, or about 0.016 to about 0.018 inches, or about 0.017 inches. The first layer may have a thickness of about 0.005 to about 0.009 inches, or about 0.007 inches. The second layer may have a thickness of about 0.008 to about 0.012 inches or about 0.010 inches.

The TPU layer may comprise any suitable thermoplastic polyurethane, such as polyesters, polyethers, polycaprolactone or the like, that is substantially optically clear and has sufficient protective properties to bond to various materials, such as glass, polycarbonate, acrylic and the like. In an exemplary embodiment, the TPU layer comprises aliphatic TPU, preferably a polyether aliphatic TPU. The polyether aliphatic TPU may have a hardness in the range of about 60 Shore A to about 100 Shore A, or about 70 Shore A to about 85 Shore A.

In embodiments, the hard coating is a scratch resistant “hard” coating comprising one or more materials that inhibit scratches from forming on the first layer. Suitable materials for the hard coating include, but are not limited to, silicones, solvent-based acrylics, solvent-free acrylics, diamond-like carbon (DLC) and combinations thereof. In addition, or alternatively, the hard coating may include additives, filters and/or binders that provide scratch resistance.

The hard coating may be applied to the first layer in any suitable manner, such as drop casting, dip coating, optical deposition, vacuum deposition, electrospinning, electro spraying, layer-by-layer deposition, spin coating and the like. In an exemplary embodiment, the hard coating is sputter coated onto the PET layer.

In embodiments, the protective structure is substantially optically clear. Thus, the structure may have a haze of less than about 4%, or less than about 3%, preferably less than or equal to about 1%. The structure may have a light transmission of greater than about 50%, or greater than about 70%, preferably greater than or equal to about 90%. The structure may have a Yellowness Index (YI) of less than about 2 or less than about 1.

In embodiments, the protective structure further comprises a third layer in contact with a surface of the second layer opposite the first layer. The third layer comprises a release liner, such as an interleaf, that may be removed from the TPU layer prior to application of the structure to a substrate, such as glass. The interleaf may have a thickness of about 0.002 inches to about 0.0006 inches, or about 0.004 inches.

In certain embodiments, the structure may be adhered to a single transparent substrate or layer, such as a glass, polycarbonate or the like. In other embodiments, the structure may be part of a laminate assembly that includes one or more additional layers adhered to the transparent substrate. The transparent substrate may comprise any optically transparent material with sufficient rigidity for the given application. Suitable materials for substrates include, but are not limited to, glass, artificial glass, polycarbonates, acrylic resins, polyesters, polyethers, and polyurethanes. In an exemplary embodiment, the transparent substrate comprises glass or polycarbonate.

In another aspect, a laminate is provided comprising one of the protective structures described above.

In another aspect, a window is provided comprising one of the protective structures described above.

In another aspect, a laminate comprises an optically transparent substrate and a protective structure adhered to the substrate. The protective structure comprises a first layer comprising a material selected from the group consisting of polycarbonate (PC), polyethylene terephthalate (PET), thermoplastic polyurethane (TPU), acrylic and a combination thereof. This first layer has a first surface and a second surface opposite the first surface. The structure further comprises a hard coating on the first surface of the first layer and a second layer comprising a thermoplastic polyurethane (TPU) in contact with the second surface of the first layer. The TPU layer is adhered to the optically transparent substrate.

In embodiments, the optically transparent substrate may comprise one of glass, artificial glass, polycarbonates, acrylic resins, polyesters, polyethers, and/or polyurethanes. In an exemplary embodiment, the transparent substrate comprises glass or polycarbonate.

In embodiments, the protective structure is bonded to a first surface of the transparent substrate and the laminate further comprises an interlayer in contact with a second surface of the transparent substrate opposite the first surface. In embodiments, the laminate comprises a second optically transparent substrate in contact with the interlayer opposite the first substrate. The second substrate may comprise glass, artificial glass, polycarbonates, acrylic resins, polyesters, polyethers, and/or polyurethanes.

In certain embodiments, the protective structure, and/or any one of the other layers of the laminate, may include one or more functional elements having solar control properties. Suitable functional elements include, but are not limited to, luminophores, ionomers, and optical elements, such as UV absorbers, UV reflectors, IR absorbers, IR reflectors and the like. In one embodiment, the functional elements comprise solar control elements, such as heat absorbers, heat reflectors, light filters, photovoltaic assemblies, electrochromic assemblies and a combination thereof.

### BRIEF DESCRIPTION OF THE DRAWINGS

The accompanying drawings, which are incorporated in and constitute a part of this specification, illustrate several embodiments of the disclosure and, together with the description, serve to explain the principles of the disclosure.

FIG. 1 is a schematic cross-sectional view of a protective structure; and

FIG. 2 is a schematic cross-sectional view of a multilayer laminate with the protective structure of FIG. 1.

### DETAILED DESCRIPTION

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Protective structure for use with laminates and laminates including the protective structure are provided that may be used in a variety of different applications, such as windows for vehicles and buildings. The laminates may be particularly useful in, for example, applications requiring shatter or impact resistance, such as shatter resistance or bulletproof glass, sunroofs, windshields, light bulbs, skylights, security doors, screen protectors, curtain walls, mass transit vehicles, marine vessels, military installations, critical infrastructure and the like. In some embodiments, the protective structure and/or the laminate may also include solar control properties, such as luminophores, ionomers, UV and/or IR light filters, heat filters or the like.

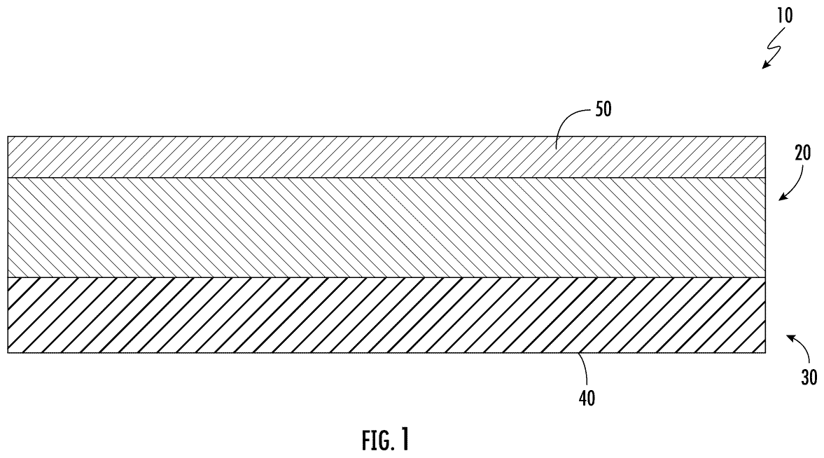

In certain embodiments, as represented in FIG. 1, a protective structure 10 comprises a first layer 30 having a hard coating 40 and a second layer of thermoplastic polyurethane (TPU) 20 in contact with a surface of the first layer 30 opposite coating 40. Structure 10 may include an optional third layer 50, such as an interleaf, release liner or the like. The interleaf 50 functions to inhibit TPU layer 20 from adhering to other substances, such as equipment, packaging and the like, and is typically removed before structure 10 is applied to a transparent substrate, such as a window or door.

As shown in FIG. 1, TPU layer 20 is preferably extruded directly onto first layer 30 to form a single structure, film or layer 10. Forming a protective structure with a single layer reduces material handling and cost. In addition, this structure has fewer independent webs and can be manufactured with a reduced thickness, thereby further reducing manufacturing costs.

Suitable materials for first layer 30 include, but are not limited to polycarbonate (PC), polyethylene terephthalate (PET), thermoplastic polyurethane (TPU), acrylic and a combination thereof. In one embodiment, the first layer comprises a blend of TPU and acrylic cross-linked together to form a harder layer. In another embodiment, the first layer 30 comprises PET.

In embodiments, structure 10 has a thickness of about 0.015 inches to about 0.020 inches, or about 0.016 to about 0.018 inches, or about 0.017 inches. The PET layer 30 may have a thickness of about 0.005 to about 0.009 inches, or about 0.007 inches. The TPU layer 20 may have a thickness of about 0.008 to about 0.012 inches or about 0.010 inches.

Combining the PET and TPU layers into a single layer allows both layers to be thinner than conventional protective films. Manufacturers typically can handle polymer layers having a thickness of about 0.015 inches or greater. Thus, by combining both layers into a single structure having a thickness of about 0.017 inches, the overall thickness of the protective structure can be reduced

Second layer 20 comprises a TPU that is substantially optically clear and has sufficient protective properties to bond to various materials, such as glass, polycarbonate, acrylic and the like. In an exemplary embodiment, the TPU comprises an aliphatic TPU, preferably a polyether aliphatic TPU. Aliphatic TPUs are staple compounds with excellent optical clarity that generally do not break down (i.e., yellow) when exposed to UV light. In addition, polyether aliphatic TPU is incredibly sticky and will adhere to many different substances, such as polycarbonate, acrylic and the like.

The polyether aliphatic TPU may have a hardness in the range of about 60 Shore A to about 100 Shore A, or about 70 Shore A to about 85 Shore A. The polyether aliphatic TPU may have a tear strength of at least about 250 lbs/in or greater, or at least about 320 lbs/in or greater as measured by ASTM D412, and an ultimate tensile strength of at least about 6000 psi, or at least about 7,000 psi as measured by ASTM D412.

In some embodiments, protective structure 10 may have a haze of less than about 3.5%, or less than about 2%, preferably less than or equal to about 1%. The structure may have a light transmission of greater than about 50%, or greater than about 50%, preferably greater than or equal to about 90%. The structure may have a Yellowness Index (YI) of less than about 2 or less than about 1.

First layer 30 may comprise an adhesion promoter to enhance the bonding between first layer 30 and TPU layer 20 and prevent delamination of the TPU from the first layer. Suitable adhesion promoters include, but are not limited to, organosilanes, organotitanates, zirconates, zircoaluminates, alkyl phosphate esters, metal organics and the like.

Hard coating 40 is a scratch resistant “hard” coating comprising one or more materials that inhibit scratches from forming on the first layer of the protective structure. Suitable materials for the hard coating include, but are not limited to, silicones, solvent-based acrylics, solvent-free acrylics, diamond-like carbon (DLC) and combinations thereof. In addition, or alternatively, the hard coating may include additives, fillers and/or binders that provide scratch resistance. Suitable binders include, but are not limited to, inorganic non-metal-based ceramics, polysilizanes, DLC, organic polymer-based resin binders, epoxy, polycarbonate, polyethylene and combinations thereof. Suitable fillers include, but are not limited to, titanium dioxide (TiO₂), zirconium dioxide (ZrO₂), aluminum oxide hydroxide (AlOOH), silicon monoxide (SiO) and combinations thereof. Suitable additives include, but are not limited to, siloxane, eruamides, MoS₂, graphite, oleic acide amide, zinc oxide (ZnO), barium oxide (BaO), lead dioxide (PbO) and combinations thereof.

In an exemplary embodiment, hard coating 40 comprises a solvent-based or solvent-free acrylic. Hard coating 40 may be applied to first layer 30 in any manner suitable, such drop casting, dip coating, optical deposition, vacuum deposition, electrospinning, electro spraying, layer-by-layer deposition, spin coating and the like. In an exemplary embodiment, coating 40 is sputter coated onto layer 30.

In certain embodiments, the TPU is selected such that it is bendable or formable to create bent or curved laminates with solar control properties. In this embodiment, the laminate may be used with curved glass, polycarbonate or the like to manufacture, for example, bow windows, arch windows, bay windows, turret windows, precurved vehicle windows, curved bullet resistant windows and the like.

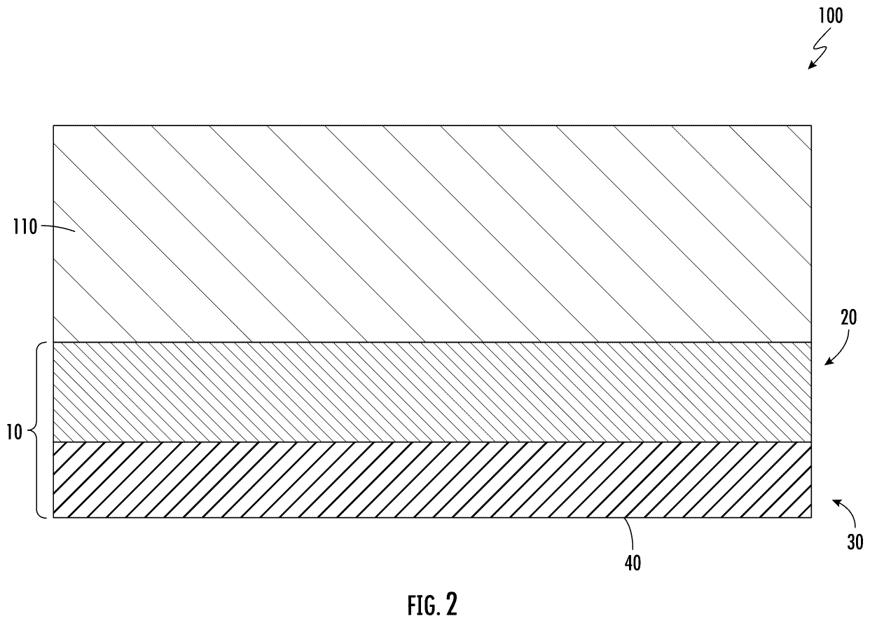

Referring now to FIG. 2, another embodiment of a laminate 100 comprises an outer layer 110 and a protective structure 10 laminated to outer layer 110. Protective structure 10 comprises a first layer 30 having a hard coating 40 and a second layer of thermoplastic polyurethane (TPU) 20 in contact with a surface of the first layer 30 opposite coating 40. The TPU layer 20 is also bonded to a surface of outer layer 110. Interleaf 50 (see FIG. 1) has been removed prior to bonding TPU layer 20 to outer layer 110. As in the previous embodiment, first layer 30 may comprise polycarbonate (PC), polyethylene terephthalate (PET), thermoplastic polyurethane (TPU), acrylic and a combination thereof, such as a cross-linked blend of acrylic and TPU.

Outer layer 110 comprises an optically transparent, substantially rigid material. Suitable materials for outer layer 110 include, but are not limited to, glass, artificial glass, or any well-known glass substitute, such as polycarbonates, acrylic resins, polyesters, polyethers, and polyurethane.

In certain embodiments, laminate 100 may further include additional interlayers and/or optically transparent layers attached to a surface of layer 110 opposite protective structure 10. In one such embodiment, the protective structure 10 is bonded to a first surface of the substrate 110 and the laminate further comprises an interlayer (not shown) bonded to a second surface of the substrate opposite the first surface. In embodiments, the laminate comprises a second optically transparent substrate (not shown) bonded to the interlayer opposite the first substrate. The second substrate may comprise glass, artificial glass, or any well-known glass substitute, such as polycarbonates, acrylic resins, polyesters, polyethers, and polyurethane.

In certain embodiments, protective structure 10, or any one of the other layers of laminate 100, may include one or more functional elements contained therein. Suitable functional elements include, but are not limited to, solar control elements, luminophores, ionomers, and optical elements, such as UV absorbers, UV reflectors, IR absorbers, IR reflectors and the like. In one embodiment, the functional elements comprise solar control elements. Suitable solar control elements include, but are not limited to, heat absorbers, heat reflectors, light filters, photovoltaic assemblies, electrochromic assemblies and a combination thereof.

In certain embodiments, protective structure 10, or any one of the other layers of laminate 100, may comprise one or more optical elements, materials and/or layers made from materials that allow the transmission of visible light and reflect or absorb UV and/or IR light. For example, an IR blocking optical element may be configured to reflect or absorb light having a wavelength of about 700 nanometers to 1 mm, preferably between about 700 nm to about 1400 nm (i.e., near-infrared wavelengths) and more preferably between about 750 nm to about 1200 nm. In one embodiment, the optical element comprises an IR-reflective coating. Suitable materials for reflecting light having wavelengths in the IR range include metal or metal-based coatings, such as double-layer or triple-layer silver coatings, liquid crystal materials that selectively operate to transmit or scatter IR light and the like.

In another embodiment, the optical element comprises an IR absorbing material, such as an IR absorbing dye, copper salt compositions, such as copper phosphonate, nanoparticles (such as zinc oxide, antimony tin oxide (ATO), lanthanum hexaboride (LaB) and the like), infrared filters, such as blue glass, interlayer films comprising infrared-shielding fine particles, and the like.

In yet another embodiment, the IR absorbing element includes IR absorbing particles, such as nanoparticles, dispersed into one of the TPU layers. In this embodiment, for example, the first TPU layer may include the UV blocking material, while the second TPU layers includes the IR blocking particles.

In certain embodiments, protective structure 10, or any one of the other layers of laminate 100, may include an optical element, layer or material that can either reflect or absorb UV light. The UV blocking optical element preferably reflects or absorbs light having a wavelength between about 10 and 410 nanometers, more preferably greater than about 380 nanometers and even more preferably between about 380 and 410 nanometers. The optical element may comprise any suitable material configured to reflect or absorb UV light, such as UV radiation absorbing, blocking or screening additives. UV radiation absorbing, blocking or screening additives suitable for the present disclosure include bezophenones, cinnamic acid derivatives, esters of benzoin acids, alicylic acid, terephthalic and isophthalic acids with resorcinol and phenols, pentamethyl piperidine derivatives, salicylates, benzotriazoles, cyanoacrylates, benzylidenes, malonates and oxalamides combined with nickel chelates and hindered amines.

Alternatively, the UV blocking optical element may comprise a light filtering layer within the TPU layer. Suitable optical elements for use herein include sheet polarizers, dichroic, reflective filter material to provide wide band UV radiation reduction and the like. For example, blue or green tinted glass with greatly reduced transmission in the UV portion or blue or green tinted polymeric interlayers, coatings or layers of UV radiation reducing paint or lacquer or polymeric films may be suitable as the UV blocking material.

In certain embodiments, the optical element comprises an IR blocker layer that can either reflect or absorb IR light and a separate UV blocker element that can either reflect or absorb UV light. The IR blocker element is preferably disposed between, and in contact with, the UV blocker element and one of the first and second thermoplastic polyurethane layers 130, 140. The IR blocker element can either reflect or absorb light having wavelengths between about 700 nanometers and about 1 mm, preferably between about 700 to about 1400 nanometers, more preferably between about 750 to about 1200 nanometers. The UV block element preferably can either reflect or absorb light having wavelengths between about 10 and 410 nanometers, preferably between about 380 and 410 nanometers.

Alternatively, the optical element may comprise a single material that blocks both UV and IR light. Suitable materials for the optical layer in this embodiment may comprise metal coatings, such as double or triple silver layers, and the like. A more complete description of optical elements for absorbing or reflecting IR and UV light can be found in commonly assigned International Application No. PCT/US2021/40300, titled Laminates with Optical Layers or Materials, filed Jul. 20, 2021, the complete description of which is incorporated herein by reference for all purposes.

In certain embodiments, protective structure, or any one of the other layers of laminate 100, may comprise one or more luminophores. In an exemplary embodiment, the luminophores are fluorophores, which are fluorescent chemical compounds that are configured to re-emit light upon light excitation. Fluorophores typically comprise several combined aromatic groups, or planar or cyclic molecules with several π bonds.

The luminophores may be configured to absorb the majority of NIR or UV photons passing through the laminate. In one embodiment, the protective structure comprises phosphorescent organic molecules or blends of multiple luminophores (such as quantum dots or organic dyes) that act to reduce reabsorption losses and enhance overall absorption efficiencies across the spectrum.

In some embodiments, the protective structure, or any one of the other layers of laminate 100, may comprise an ionomer or a polymer composed of repeat units of both electrically neutral repeating units and ionized units covalently bonded to the polymer backbone as pendant group moieties. A certain mole percent, e.g., 15% or less, is ionized. The ionomer may have unique physical properties, such as electrical conductivity and viscosity.

In certain embodiments, the protective structure, or any one of the other layers of laminate 100, may include photovoltaic, electrochromic and/or other functionalities for conductive performance. In one such embodiment, laminate 100 comprises a photovoltaic assembly therein. For example, quantum dots can be provided within protective structure 10, or any one of the other layers of laminate 100, Another suitable alternative to quantum dots for energy generation is organic photovoltaic (OPV) cells, which may be employed here. Organic photovoltaic technology is rapidly emerging due to improving cell efficiency, positive performance lifetime, and demonstrated potential for roll-to-roll manufacturing using solution processing. OPV may be an attractive alternative since it offers absorbers in any color, and the ability to make efficient transparent devices. A diversity of organic materials can be used to design and synthesize the absorber, acceptor and interfaces, another benefit. Organic photovoltaic cells may be applied using thin-film deposition such as by sputtering and pulsed-laser deposition to create this thin-film OPV for energy generation. A more complete description of a suitable photovoltaic assembly can be found in commonly assigned co-pending U.S. Provisional Patent Application Ser. No. 63/470,128 (“Functional Glass and Artificial Glass Laminates”), filed May 31, 2023, the complete disclosure is incorporated herein by reference for all purposes.

While the materials and products formed from these materials have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in one aspect, a first embodiment is a protective structure comprising a first layer comprising a material selected from the group consisting of polycarbonate (PC), polyethylene terephthalate (PET), thermoplastic polyurethane (TPU), acrylic and a combination thereof, the first layer having a first surface and a second surface opposite the first surface, a hard coating on the first surface of the first layer and a second layer comprising a thermoplastic polyurethane (TPU) in contact with the second surface of the first layer.

A second embodiment is the first embodiment, wherein the structure has a thickness of about 0.015 inches to about 0.020 inches

A third embodiment is any combination of the first two embodiments, wherein the thickness is about 0.016 to about 0.018 inches.

A 4^{th} embodiment is any combination of the first 3 embodiments, wherein the TPU comprises an aliphatic TPU.

A 5^{th} embodiment is any combination of the first 4 embodiments, wherein the aliphatic TPU is a polyether based aliphatic TPU.

A 6^{th} embodiment is any combination of the first 5 embodiments, wherein the first layer has a thickness of about 0.005 to about 0.009 inches.

A 7^{th} embodiment is any combination of the first 6 embodiments, wherein the second layer has a thickness of about 0.008 to about 0.012 inches.

An 8^{th} embodiment is any combination of the first 7 embodiments, wherein the protective structure is substantially optically clear.

A 9^{th} embodiment is any combination of the first 8 embodiments, wherein the protective structure has a haze of less than about 1%.

A 10^{th} embodiment is any combination of the first 9 embodiments, wherein the protective structure has a light transmission of greater than about 90%.

An 11^{th} embodiment is any combination of the first 10 embodiments, wherein the second layer is extruded onto the first layer.

A 12^{th} embodiment is any combination of the first 11 embodiments, wherein the hard coating comprises a material selected from the group consisting of silicone and acrylic.

A 13^{th} embodiment is any combination of the first 3 embodiments, further comprising a third layer in contact with a surface of the second layer opposite the first layer, the third layer comprising a release liner.

A 14^{th} embodiment is any combination of the first 13 embodiments, wherein the coating is sputter coated to the first layer.

A 15^{th} embodiment is any combination of the first 14 embodiments, wherein the first layer comprises PET.

In another aspect, a laminate is provided comprising the protective structure of any combination of the first 15 embodiments.

In another aspect, a window is provided comprising the protective structure of any combination of the first 15 embodiments.

In another aspect, a shatter-resistant window is provided comprising the protective structure of any combination of the first 15 embodiments.

In another aspect, a first embodiment is a laminate comprising an optically transparent substrate and a protective structure adhered to the substrate. The protective structure comprises a first layer comprising a material selected from the group consisting of polycarbonate (PC), polyethylene terephthalate (PET), thermoplastic polyurethane (TPU), acrylic and a combination thereof, the first layer having a first surface and a second surface opposite the first surface, a hard coating on the first surface of the first layer and a second layer comprising a thermoplastic polyurethane (TPU) in contact with the second surface of the first layer. The TPU layer is in contact with the optically transparent substrate.

A second embodiment is the first embodiment, wherein the substrate comprises a material selected from the group consisting of glass, artificial glass, polycarbonate, acrylic, polyester, polyether, and polyurethane.

A third embodiment is any combination of the first 2 embodiments, wherein the substrate comprises glass or polycarbonate.

A 4^{th} embodiment is any combination of the first 3 embodiments, wherein the structure has a thickness of about 0.015 inches to about 0.020 inches

A 5^{th} embodiment is any combination of the first 4 embodiments, wherein the thickness is about 0.016 to about 0.018 inches.

A 6^{th} embodiment is any combination of the first 5 embodiments, wherein the TPU comprises an aliphatic TPU.

A 7^{th} embodiment is any combination of the first 6 embodiments, wherein the first layer has a thickness of about 0.005 to about 0.009 inches.

An 8^{th} embodiment is any combination of the first 7 embodiments, wherein the second layer has a thickness of about 0.008 to about 0.012 inches.

A 9^{th} embodiment is any combination of the first 8 embodiments, wherein the protective structure is substantially optically clear.

A 10^{th} embodiment is any combination of the first 9 embodiments, wherein the second layer is extruded onto the first layer.

An 11^{th} embodiment is any combination of the first 10 embodiments, wherein the coating comprises a material selected from the group consisting of acrylic and silicone.

A 12^{th} embodiment is any combination of the first 11 embodiments, further comprising a third layer in contact with a surface of the second layer opposite the first layer, the third layer comprising a release liner.

A 13^{th} embodiment is any combination of the first 12 embodiments, wherein the coating is sputter coated to the first layer.

A 14^{th} embodiment is any combination of the first 13 embodiments, wherein the protective v is in contact with a first surface of the substrate, the laminate further comprising an interlayer in contact with a second surface of the substrate opposite the first surface.

A 15^{th} embodiment is any combination of the first 14 embodiments, further comprising a second optically transparent substrate in contact with the interlayer opposite the first substrate.

A 16^{th} embodiment is any combination of the first 15 embodiments, wherein the second substrate comprises glass or polycarbonate.

A 17^{th} embodiment is any combination of the first 16 embodiments, wherein the laminate is bulletproof.

A 18^{th} embodiment is any combination of the first 17 embodiments, wherein the first layer comprises PET.

In another aspect, a window is provided comprising the laminate of any combination of the first 18 embodiments.

In another aspect, a shatter-resistant window is provided comprising the laminate of any combination of the first 18 embodiments.

What is claimed is:

1. A protective structure comprising:
a first layer comprising a material selected from the group consisting of polycarbonate (PC), polyethylene terephthalate (PET), thermoplastic polyurethane (TPU), acrylic and a combination thereof, the first layer having a first surface and a second surface opposite the first surface;
a hard coating on the first surface of the first layer; and
a second layer comprising a thermoplastic polyurethane (TPU) in contact with the second surface of the first layer.

2. The protective structure of claim 1, wherein the structure has a thickness of about 0.015 inches to about 0.020 inches.

3. The protective structure of claim 2, wherein the thickness is about 0.016 to about 0.018 inches.

4. The protective structure of claim 1, wherein the second layer is extruded onto the first layer to form a single structure.

5. The protective structure of claim 1, wherein the first layer has a thickness of about 0.005 to about 0.009 inches.

6. The protective structure of claim 4, wherein the second layer has a thickness of about 0.008 to about 0.012 inches.

7. The protective structure of claim 1, wherein the protective structure has a haze of less than about 1%.

8. The protective structure of claim 1, wherein the protective structure has a light transmission of greater than about 90%.

9. The protective structure of claim 1, wherein the hard coating comprises a material selected from the group consisting of acrylics and silicones.

10. The protective structure of claim 1, further comprising a third layer in contact with a surface of the second layer opposite the first layer, the third layer comprising a release liner.

11. The protective structure of claim 1, wherein the hard coating is sputter coated to the first layer.

12. The protective structure of claim 1, wherein the first layer comprises PET.

13. A window comprising the protective structure of claim 1.

14. A laminate comprising:
an optically transparent substrate; and
a protective structure adhered to the substrate, the protective structure comprising:
a first layer comprising a material selected from the group consisting of polycarbonate (PC), polyethylene terephthalate (PET), thermoplastic polyurethane (TPU), acrylic and a combination thereof, the first layer having a first surface and a second surface opposite the first surface;
a hard coating on the first surface of the first layer; and
a second layer comprising a thermoplastic polyurethane (TPU) in contact with the second surface of the first layer and in contact with the optically transparent substrate.

15. The laminate of claim 14, wherein the substrate comprises a material selected from the group consisting of glass, artificial glass, polycarbonate, acrylic, polyester, polyether, and polyurethane.

16. The laminate of claim 14, wherein the protective structure has a thickness of about 0.015 inches to about 0.020 inches.

17. The laminate of claim 14, wherein the second layer is extruded onto the first layer to form a single structure.

18. The laminate of claim 14, wherein the first layer has a thickness of about 0.005 to about 0.009 inches, and the second layer has a thickness of about 0.008 to about 0.012 inches.

19. The laminate of claim 14, wherein the hard coating comprises a material selected from the group consisting of acrylics and silicones.

20. The laminate of claim 14, further comprising a third layer in contact with a surface of the second layer opposite the first layer, the third layer comprising a release liner.

21. The laminate of claim 14, wherein the protective structure is in contact with a first surface of the substrate, the laminate further comprising an interlayer in contact with a second surface of the substrate opposite the first surface.

22. The laminate of claim 21, further comprising a second optically transparent substrate in contact with the interlayer opposite the first substrate.

23. The laminate of claim 14, wherein the first layer comprises PET.
